(19) United States
(12) Patent Application Publication
(10) Pub. No.: US 2012/0137845 A1
(43) Pub. Date: Jun. 7, 2012

(54) CUTTING DEVICE

(75) Inventor: Günther Weber, Gross Nemerow (DE)

(73) Assignee: WEBER MASCHINENBAU GMBH BREIDENBACH, Breidenbach (DE)

(21) Appl. No.: 13/376,354

(22) PCT Filed: May 19, 2010
(86) PCT No.: PCT/EP2010/003075

§ 371 Date: Feb. 21, 2012

(30) Foreign Application Priority Data
Jun. 3, 2009 (DE) 10 2009 023 749.6

(51) Int. Cl. B26D 7/01; B26D 7/06

(52) U.S. Cl. 83/13; 83/421

(57) ABSTRACT

A device for slicing a food product is provided including a product feed and an adjustment apparatus. The product feed feeds the food product to be sliced along a product conveying direction to a cutting plane, in which a cutting blade moves. The food product has a contour and a front product end region. The product feed includes at least one end element which has at least one of a product guiding support surface and a product contact surface for the front product end region. The adjustment apparatus adjusts the at least one end element to have a component of movement generally perpendicular to the product conveying direction. The adjustment apparatus is configured to adjust at least one of the product guiding support surface and the product contact surface of the at least one end element to the contour of the food product during a slicing operation.

### CROSS-REFERENCES TO RELATED APPLICATIONS

This patent application claims priority to International Application No. PCT/EP2010/003075 filed on May 19, 2010, which claims priority to German application DE102009023749.6 filed on Jun. 3, 2009, both of which are incorporated herein by reference in their entirety.

### FIELD OF THE INVENTION

The present invention relates to a device or an apparatus for cutting or slicing food products, in particular to a high-performance slicer, having a product feed which feeds a product to be sliced along a product conveying direction to a cutting plane in which a cutting blade moves, in particular in a rotating and/or revolving manner. The product feed includes at least one end element which has a product-conducting support surface and/or contact surface for a front product end region.

### BACKGROUND

Some types of cutting apparatus serve to slice food products such as sausage, cheese, ham and the like at a high cutting frequency. The end element fixes the front product end region by means of the support surface and/or contact surface and supports it with respect to the cutting blade.

There is the possibility that the front product end region is not constantly supported by the support surface and/or contact surface during slicing due to an irregular product contour. This can have the result that product guide at the front product end is not present with respect to the cutting blade, which can have negative effects on the quality of the product slices.

### SUMMARY

In one embodiment of the invention a device is provided that improves the cutting quality. In particular the slicing of products having an irregular contour is made possible with an unchanged quality.

In another embodiment, a device for slicing a food product is provided including a product feed and an adjustment apparatus. The product feed feeds the food product to be sliced along a product conveying direction to a cutting plane, in which a cutting blade moves. The food product has a contour and a front product end region. The product feed includes at least one end element which has at least one of a product guiding support surface and a product contact surface for the front product end region. The adjustment apparatus adjusts the at least one end element to have a component of movement generally perpendicular to the product conveying direction. The adjustment apparatus is configured to adjust at least one of the product guiding support surface and the product contact surface of the at least one end element to the contour of the food product during a slicing operation.

In accordance with an embodiment of the invention, the end element can be adjusted by means of an adjustment apparatus to have a component of movement generally perpendicular to the product conveying direction. The adjustment apparatus is configured to adjust the support and/or contact surface of the end element during the slicing operation to follow the contour of the product.

It can be ensured by the adjustment that the front product end region is generally always in contact with the support surface and/or contact surface of the end element and is thus supported. If there is the risk that the front product end region moves away from the support surface and/or contact surface due to an irregular product contour, the adjustment apparatus provides that the support surface and/or contact surface of the end element carries out a corresponding equalization movement. The product is thus correctly guided generally at all times, whereby a uniformly high cutting quality is generally ensured.

In accordance with an embodiment of the present invention, the end element defines a cutting edge adjacent to the cutting plane and terminating the support surface and/or contact surface. The cutting edge cooperates as a counter blade with the cutting blade in cutting operation to ensure a relatively high cutting quality.

The end element can adjoin a side abutment that has a contact surface extending in the product conveying direction for positioning the product and/or can adjoin a product support having a support surface for the product. The product to be sliced can thus be positioned and guided along its total length, with the front product end region being guided by the support surface and/or contact surface of the end element and the remaining product region being guided by the contact surface of the side abutment or by the support surface of the product support. The support surfaces and/or contact surfaces of the end element, on the one hand, and of the side abutment or of the product support, on the other hand, do not have to be directly adjacent one another. That is, a gap can be provided between the contact surface of the end element and the contact surface of the side abutment, and/or between the support surface of the end element and the support surface of the product support.

In accordance with an embodiment of the present invention, the end element is adjustable relative to a side abutment that has a contact surface extending in the product conveying direction for positioning the product, and/or is adjustable relative to a product support having a support surface for the product. A movement of the product end region relative to the end element can thereby be compensated according to one embodiment of the invention by the positioning of the product relative to the cutting blade that is fixed by the relatively large-area side abutment, or by the product support and the support surface and/or contact surface of the end element that is adjusted for the front product end region relative to the side abutment or to the product support.

In accordance with another embodiment of the present invention, the side abutment and/or the product support is/are adjustable, with the end element being adjustable independently of the side abutment and/or of the product support. The adjustability of the side abutment or of the product support makes it possible to slice products having a different cross-section at one and the same cutting apparatus and in so doing always to ensure correct positioning of the respective product relative to the cutting blade.

In accordance with yet another embodiment of the present invention, the end element, which in one embodiment may include an L-shaped profile, has both a vertical contact surface and a horizontal support surface, with the end element being adjustable in the horizontal direction to adjust its contact surface to follow a lateral product contour and/or is adjustable in the vertical direction to adjust its support surface to follow a bottom product contour. The product guidance can be further improved by two such guide surfaces for the product end region aligned at right angles to one another. A one-piece, L-shaped end element can be provided, for example.

The support surface(s) and/or contact surface(s) does/do not have to be planar, but can rather also be differently shaped and can in particular be made curved.

In accordance with another embodiment of the present invention, at least two end elements are provided that are adjustable independently of one another. The product guiding support surfaces and/or contact surfaces of the two end elements can in particular be arranged at generally right angles to one another. Product irregularities or cross-sectional variations of the most varied kind can be equalized by the adjustability of the support surfaces and/or contact surfaces. The number of end elements adjustable independently of one another depends on the respective use. An annular arrangement of a plurality of end elements could, for example, also be provided which are positioned along the periphery of the front product end region, and are individually adjusted so that a guidance and support of the front product end region results at all sides parallel to the cutting plane. Alternatively, the end element can, however, also be made in the manner of a molded tray surrounding the product to be sliced in full or in part.

In yet another embodiment of the present invention, the adjustment apparatus may include a power drive to ensure a sufficiently fast and reliable adjustment of the end element.

A control device can be associated with the adjustment apparatus and is configured to control the adjustment apparatus in dependence on the contour of the product. A direct adjustment is ensured by the control of the adjustment apparatus in accordance with the contour of the product. The compensation of an offset of the front product end region adopted on the supply of the product in the direction of the cutting blade can therefore so-to-say take place in an anticipatory manner without the front product end region first moving away from the support surface and/or contact surface of the end element.

In accordance with another embodiment of the invention, at least one detection device, in particular a detection device working in accordance with a light cutting process or with a distance measuring process, is provided that is configured to detect at least a part of the contour of the product, in particular in a contactless manner, and to transfer corresponding contour data to the control device. In many high performances slicers, detection devices interposed before the cutting unit are standard to determine the contour data required for the regulation of the product slice weight or of the portion weight, which may be utilized in various embodiments of the invention. The control device can control the adjustment apparatus for the purpose of adjusting with reference to the determined contour data. In one embodiment, the detection device for detecting a plurality of cross-sectional surfaces of the product may be formed along a longitudinal product axis.

In accordance with yet another embodiment of the invention, a memory device in which the contour data can be stored is associated with the control device. In particular contour data of typical products can be stored in the memory device and can be used in each case for the control. With knowledge of the product to be sliced, the adjustment apparatus can thus be correctly controlled without previously measuring the cross-sectional shape of the product in detail.

In one embodiment, the invention can also be used for such apparatus in which a plurality of products are sliced simultaneously.

In another embodiment of the invention, a method of slicing a food product is provided. The method includes feeding a food product to be sliced by a product feed along a product conveying direction to a cutting plane in which a cutting blade moves. The method includes guiding a front product end region by at least one end element relative to the product conveying direction, with the at least one end element having at least one of a product guiding support surface and a product contact surface for the front product end region. The method includes adjusting at least one of the product guiding support surface and the product contact surface of the at least one end element with a component generally perpendicular to the product conveying direction to follow a contour of the food product.

Various embodiments of the invention are also illustrated in the drawings.

### BRIEF DESCRIPTION OF THE DRAWINGS

The invention will be described in the following with reference to the drawings.

FIG. 1 schematically shows a plan view of a cutting device in accordance with an embodiment of the invention; and

FIG. 2 shows a side view of the cutting device of FIG. 1.

### DETAILED DESCRIPTION

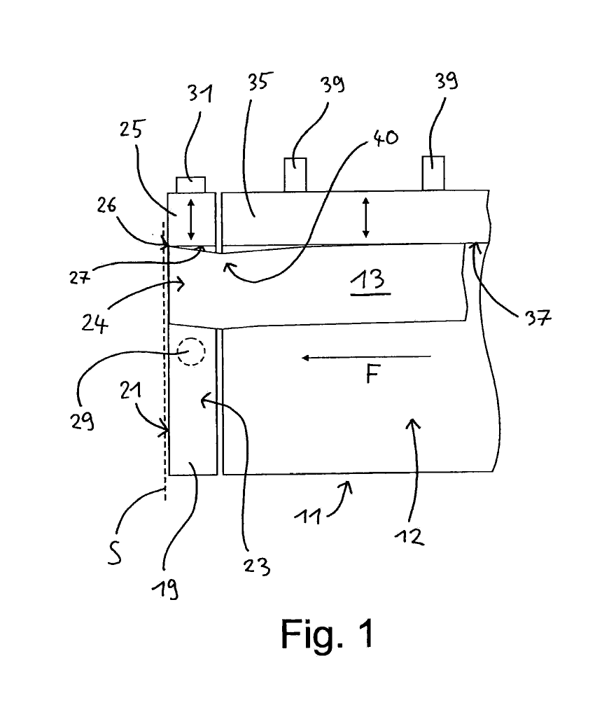

In the embodiment shown, the product feed of a high performance slicer includes a continuous belt conveyor 11 on which a product 13 to be sliced lies which is only shown in FIG. 1. The belt conveyor 11 thus forms a product support having a support surface 12 and conducts the product 13 in a product conveying direction F to a cutting plane S in which a cutting blade (not shown) moves to cut slices of predefinable thickness from the front product end at a relatively high cutting frequency.

The specific embodiment of the product feed is not significant in connection with the invention. A free-running conveyor belt or a roller conveyor can, for example, be provided instead of a driven continuous conveyor belt, where the product may lay on a free-running conveyor or roller conveyor, and is advanced in the direction of the cutting plane 13 by a product holder engaging into the rear product end, for example.

The belt conveyor 11 ends at a specific spacing in front of the cutting plane S which amounts to about 20 mm, for example. A horizontal end element 19 is arranged in the intermediate space between the end of the belt conveyor 11 and the cutting plane S. The horizontal end element reaches up to the cutting plane S and defines a horizontal cutting edge 31 which is directly adjacent to the cutting plane S and which cooperates as a counter-blade with the cutting blade in cutting operation. The horizontal end element 19 provides a horizontal support surface 23 for the front product end region 24 that is disposed substantially at the same level as the support surface 12 of the belt conveyor 11, and forms the horizontal end of the product feed.

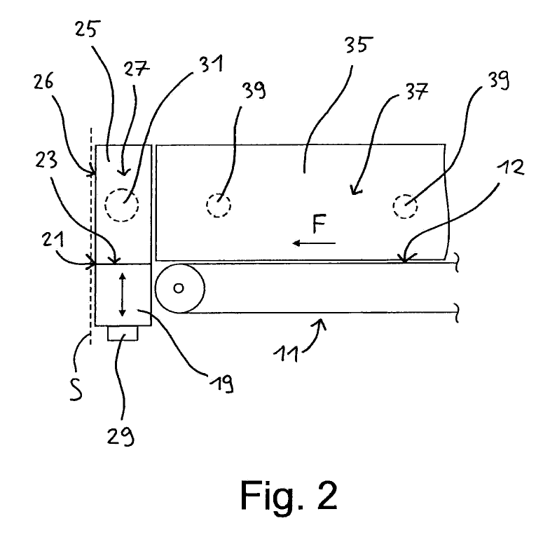

In a similar manner, a separate vertical end element 25 is provided which provides a vertical contact surface 27 for the front product end region 24 and defines a vertical cutting edge 26. The vertical contact surface 27 extends over a distance in the product conveying direction F of substantially equal size to the horizontal support surface 23. If the application requires, the vertical contact surface 27 could also be made wider or narrower than the horizontal support surface 23. The horizontal end element 19 is coupled at its rear side to an adjustment apparatus 29. It is indicated by the double arrows in FIGS. 1 and 2 that the adjustment apparatus 29 is configured such that the main adjustment direction extends generally perpendicular to the horizontal support surface 23 and generally perpendicular to the product conveying direction F. In a similar manner, the vertical end element 25 is coupled at its lower side to an adjustment apparatus 31 by means of which it is adjustable generally perpendicular to the vertical contact surface 27 and perpendicular to the product conveying direction F.

In specific applications, the total product feed can be arranged inclined with respect to the horizontal to achieve a better dropping of the cut off product slices. In this configuration, the term “horizontal support surface” designates the surface by which the product 13 is downwardly supported even if this surface is not actually aligned generally horizontally.

The product feed may also have a side abutment 35 which has a contact surface 37 extending along the product conveying direction F for positioning the product 13. The side abutment 35 is coupled at its rear side to a plurality of adjustment apparatuses 39 which are able to adjust the contact surface 37 at a substantially right angle to the product conveying direction F.

The adjustment apparatus 29, 31 of the end elements 19, 25 are each power driven and are controlled by a common control device or by separate control devices (not shown) which is configured to adjust the support surface 23 and the contact surface 27 to follow the contour of the product 13 during a slicing operation. The side abutment 55 can be adjusted in the lateral direction independently of this adjustment movement by means of the adjustment apparatus 39. A memory device, likewise not shown, in which contour data of the products can be stored can be associated with the control device. The product feed furthermore has a detection device, also not shown, for the contactless detection of the contour of the product 13 to be sliced. The detection apparatus can, for example, work in accordance with the light cutting process or in accordance with a distance measuring process such as is known in the prior art. The detection device can in particular be configured as a product scanner that detects a plurality of cross-sectional surfaces of the product along a longitudinal product axis and that is interposed in front of the actual cutting unit.

The operation of the cutting apparatus in accordance with an embodiment of the invention will be described in the following. To slice the product 13, it is first placed onto the belt conveyor 11 and brought into contact with the contact surface 37 of the side abutment 35. Optionally, a power driven gripping claw can be brought into engagement with the rear product end to affect or assist the product advance. The side abutment 35 is placed into a predefined position by means of the adjustment apparatus 39 before the start of the cutting operation to define the lateral position of the product 13 relative to the cutting blade. The defining of the position of the side abutment 35 takes place such that the cutting blade cuts through the product in a manner as effective as possible with respect to its shape.

The contour of the product 13 is, for example, determined by means of the detection apparatus before the start of the cutting operation to obtain the data required for the regulation of the product slice weight or of the portion weight. Contour data corresponding to the determined contour is furthermore transferred to the control device. The contour determination can, but does not have to be completed before the start of cutting, and may also take place during cutting.

The horizontal end element 19 and the vertical end element 25 are positioned by means of the adjustment apparatus 29, 31 such that the horizontal support surface 23 is at the same level as the support surface 12 of the belt conveyor 11, and the vertical contact surface 27 is in a plane with the contact surface 37 of the side abutment 35.

Slicing operation is subsequently started. The product 13 is advanced along the product conveying direction F and is sliced by means of the cutting blade, which cooperates with the cutting edges 21, 26 of the end elements 19, 25.

A lateral deformation 40 of the product 13 is shown by way of example in FIG. 1. The deformation 40 would have the result with a constant position of the vertical end element 19 and of the side abutment 35 that the front product end region 24 moves away from the vertical contact surface 27 on the advancing of the product 13. This unwanted moving away is compensated in that the vertical end element 25 is adjusted to follow the contour of the product 13 using the contour data. In the same way, it is prevented by means of an adjustment of the horizontal end element 19 that the front product end region 24 moves away from the horizontal support surface 23. The front product end region 24 is thus correctly supported or guided generally at all times during slicing operation. The position of the product 13 relative to the cutting blade is not influenced by the adjustment of the end elements 19, 25.

A further side abutment could be provided at the left side in FIG. 1 for the additional fixing of the product 13. Furthermore, the product 13 could be held from above by means of a hold-down arrangement or by means of another belt conveyor.

The contour data can be provided in a variety of manners. Instead of a product scanner, separate sensors can be provided, for example, laser scanners, mechanical scanners or ultrasonic sensors, to detect the current contour. Alternatively, contour data stored in the memory device of a reference product corresponding to the product 13 to be sliced could also be accessed. In this manner, products having an extremely irregular cross-section (e.g. non-processed cheese in semi-round pieces) can also be sliced without problem.

The continuous adjustment movement of the support surface 23 and of the contact surface 27, including the corresponding cutting edges 21, 26, provides overall that the product 13 is correctly guided and supported generally at all times during slicing.

1-15. (canceled)

16. A device for slicing a food product comprising:
a product feed which feeds the food product to be sliced along a product conveying direction to a cutting plane in which a cutting blade moves, the food product having a contour and a front product end region,
the product feed including at least one end element which has at least one of a product guiding support surface and a product contact surface for the front product end region, and
an adjustment apparatus for adjusting the at least one end element to have a component of movement generally perpendicular to the product conveying direction, the adjustment apparatus being configured to adjust at least one of the product guiding support surface and the product contact surface of the at least one end element to the contour of the food product during a slicing operation.

17. The device in accordance with claim 16, the cutting blade being configured to move in at least one of a rotating manner and a revolving manner.

18. The device in accordance with claim 16, the at least one end element defining a cutting edge adjacent to the cutting plane and forming a termination of at least one of the product guiding support surface and the product contact surface.

19. The device in accordance with claim 16, comprising a side abutment for the food product and having a contact surface extending in the product conveying direction for positioning the food product and the at least one end element adjoining the side abutment.

20. The device in accordance with claim 19, the at least one end element being adjustable relative to the side abutment.

21. The device in accordance with claim 16, wherein a side abutment is provided for a product adjoining a product support having a support surface for the food product and the at least one end element adjoining the side abutment.

22. The device in accordance with claim 21, the at least one end element being adjustable relative to the side abutment.

23. The device in accordance with claim 21, at least one of the side abutment and the product support being adjustable, with the at least one end element being adjustable independently of at least one of the side abutment and the product support.

24. The device in accordance with claim 16, the at least one end element having a vertical contact surface and a horizontal support surface, with the at least one end element being adjustable in at least one of a horizontal direction to adjust the vertical contact surface to a lateral product contour and a vertical direction to adjust the horizontal support surface to a bottom product contour.

25. The device in accordance with claim 16, at least first end element and a second end element being provided and being adjustable independently of one another.

26. The device in accordance with claim 16, the adjustment apparatus including a power drive.

27. The device in accordance with claim 16, comprising a control device associated with the adjustment apparatus, the control device controlling the adjustment apparatus in dependence on the contour of the food product.

28. The device in accordance with claim 27, comprising at least one detection device configured to detect at least a part of the contour of the food product to generate contour data and to transfer the contour data to the control device.

29. The device in accordance with claim 27, including a memory device associated with the control device and in which contour data of the food product is stored.

30. The device in accordance with claim 28, the at least one detection device working in accordance with one of a light cutting process or with a distance measurement process.

31. The device in accordance with claim 28, the at least one detection device being a non-contact detector.

32. The device in accordance with claim 28, comprising a longitudinal product axis and a plurality of cross-sectional surfaces along the longitudinal product axis, the at least one detection device being configured for detecting the plurality of cross-sectional surfaces.

33. A method of slicing a food product, comprising the steps of:
feeding a food product to be sliced by a product feed along a product conveying direction to a cutting plane in which a cutting blade moves;
guiding a front product end region by at least one end element relative to the product conveying direction, with the at least one end element having at least one of a product guiding support surface and a product contact surface for the front product end region, and
adjusting at least one of the product guiding support surface and the product contact surface of the at least one end element with a component generally perpendicular to the product conveying direction to follow a contour of the food product.

34. The method in accordance with claim 33, at least one of the product guiding support surface and the product contact surface being adjusted substantially throughout slicing the food product.

35. The method in accordance with claim 33, the food product contacting a side abutment during slicing and the side abutment having a contact surface extending in the product conveying direction for the positioning of the food product, with the at least one end element including the product contact surface extending generally parallel to the contact surface of the side abutment, the method comprising adjusting the at least one end element relative to the side abutment.
